(19) United States
(12) Patent Application Publication
(10) Pub. No.: US 2014/0354820 A1
(43) Pub. Date: Dec. 4, 2014

(54) SYSTEM AND METHOD FOR LIVE SURVEILLANCE PROPERTY MONITORING

(71) Applicant: Patroleum Inc, Las Vegas, NV (US)

(72) Inventors: Daniel Danialian, Las Vegas, NV (US); Armita Amini, Las Vegas, NV (US)

(73) Assignees: Daniel Danialian, Las Vegas, NV (US); Armita Amini, Las Vegas, NV (US)

(21) Appl. No.: 14/269,829

(22) Filed: May 5, 2014

Related U.S. Application Data
(60) Provisional application No. 61/819,203, filed on May 3, 2013.

(51) Int. Cl. G06K 9/00; H04L 29/08; H04N 7/18

(52) U.S. Cl. CPC G06K 9/00771; H04N 7/181; H04L 67/12
USPC 348/154

(57) ABSTRACT

A system and method for live surveillance property monitoring comprises camera being installed strategically on a property under surveillance for capturing a video, a server for hosting a video management software and a video analytics software, network for providing data communication access, router for forwarding data over the network, display device for displaying said video, outdoor access panel for turning on and off the system and speaker for announcements wherein a virtual fence is superimposed on the video captured through the camera by the video analytics software. The video is forwarded by the router to the server through the network. Any movement occurring across the virtual fence is detected by the video analytics software and the video management software then transmits the video to the display device for monitoring by an agent at a monitoring station whereby the agent takes appropriate action according to situation.

### CROSS-REFERENCE TO RELATED APPLICATIONS

This application claims the benefit of U.S. Provisional Application No. 61/819,203, filed May 3, 2013, the contents of which are incorporated herein by reference.

### FIELD OF THE INVENTION

The present invention generally relates to security systems. More particularly, the present invention relates to a system and a method of providing live surveillance for a property.

### BACKGROUND OF THE INVENTION

As can be appreciated by one skilled in the art, it is impractical for a monitoring station to simultaneously monitor dozens or hundreds of residential properties, unless the monitoring station or similar surveillance facility has the personnel to watch the residential properties on a 24/7/365 basis using dozens or hundreds of active monitor screens. Such a system would require a large number of personnel stationed at respective monitor screens, resulting in costly employee overhead. Accordingly, the resulting cost to the consumer for protection of a residence might become prohibitive.

Moreover, the probability of false alarms resulting from such a large number of monitors and monitored homes becomes problematic. It is not uncommon for a monitoring station to constantly respond to alarms, some of which may be false, by calling the affected customer to ask if everything is “okay” on the premises.

In conventional monitoring systems, sensors are used on customer doors, windows, and other possible entry points, where these remote sensors are not activated until an unauthorized entry is occurring. That is, the conventional monitoring station does not respond, or issue an alarm unless, for example, a burglar is in the process of breaking in. It can thus be appreciated that conventional electronic monitoring does not inform the monitoring station of specifics except, for example, that a door has been opened on the premises. Also, it is clear that an intruder needs to physically “break in” to the secured area for the alarm to go off at the monitoring station. Because the intruder has broken in to the monitored area before the monitoring station realizes the potential problem, this leaves little or no time for police to respond effectively.

If the monitoring station is providing constant monitoring of display monitors to provide early detection of unauthorized entry, as explained above, the monitoring service requires additional equipment and personnel and, thus, becomes extremely expensive. Such expense may be practical primarily for large, commercial properties and businesses, but is not practical for personal residences or small business concerns.

Consequently, there exists in the art a long felt need for a system and method for live surveillance property monitoring which can monitor a large number of residences without the need for a correspondingly large number of monitoring personal. There also exists in the art a long felt need for a system and method for live surveillance property monitoring which is free from false alarms. Additionally, there exists in the art a long felt need for a system and method for live surveillance property monitoring which does not require the need to constantly watch the video feed from each individual target. There also exist in the art a long felt need for a system and method for live surveillance property monitoring which operates without the interruption of service and is reliable.

### OBJECTS OF THE INVENTION

An object of the present invention is to provide a system and method for live surveillance property monitoring which can monitor a large number of residences without the need for a correspondingly large number of monitoring personal.

Another object of the present invention is to provide a system and method for live surveillance property monitoring which provides greater security for a user's property as compared to prior art systems.

A still another object of the invention is to provide a system and method for live surveillance property monitoring which is free from false alarms.

Yet another object of the present invention is to provide a system and method for live surveillance property monitoring which does not require the need to constantly watch the video feed from each individual target.

A further object of the present invention is to provide a system and method for live surveillance property monitoring which enables monitoring station agents to see video feed in high definition, and in real time.

A still further object of the invention is to provide a system and method for live surveillance property monitoring which allows the using customer to turn live surveillance monitoring on or off at the customer premises.

Yet another object of the present invention is to provide a system and method for live surveillance property monitoring which doesn't wait for the burglar to break a window or open a door for the alarm to go off.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

In one embodiment of the present invention, the system for live surveillance property monitoring comprises wireless or wired carriers for providing Internet access, router for performing the traffic directing functions on the Internet, server or similar device, video management software and video analytics software which are resident in the server, camera for viewing and recording an intruder and an outdoor access panel accessible by a customer. The cameras, being strategically positioned, cover an area to be monitored for detecting an intruder. The camera is connected to the server through wireless or wired network and the server functions to configure the router and all system components remotely whereby the system of the present invention enables monitoring station agent at a monitoring station to see a video feed. The selected video display monitors are under the control of video management system and video analytics and the selected videos are being watched live and the monitoring station agent is able to immediately determine what is going on at a monitored area. The outdoor access panel is used as an access and alarming pad, allowing the customer to turn live the system for live surveillance property monitoring on or off at the customer premises.

In another embodiment of the present invention, the method for live surveillance property monitoring comprises positioning of camera to cover an area to be monitored for detecting any intruder, connecting the camera to a wireless or wired carriers via the server, configuring the router and all system components remotely by the server, watching a video feed by the monitoring station agent at a monitoring station, controlling selected video display monitors by a Video Analytics Software, watching live selected video display monitors by monitoring station agent and determining immediately what is going on at a monitored area by the monitoring station agent, wherein a customer can turn live a system for live surveillance property monitoring on or off at the using customer premises using outdoor access panel.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a diagrammatical illustration of a property with camera and other accessories installed in accordance with an embodiment of live surveillance property monitoring system of the present invention;

FIG. 2 is a pictorial illustration of a property under surveillance on a monitoring system when an intruder crosses a virtual line superimposed around the property under surveillance in accordance with an embodiment of the present invention;

FIG. 3 illustrates the general architecture of a system that operates in accordance with one embodiment of the present invention;

FIG. 4 illustrates a flow diagram showing a process in accordance with one embodiment of the present invention;

FIG. 5 illustrates a perspective view of a property under surveillance on a monitoring system with a virtual line superimposed around the property in accordance with an embodiment of the present invention;

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The invention is now described with reference to the drawings, wherein like reference numerals are used to refer to like elements throughout. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention. In the following description, for purpose of explanation, numerous specific details are set forth in order to provide a thorough understanding thereof. It may be evident, however, that the invention can be practiced without these specific details.

The shortcomings of the present art, described above, are addressed and solved by the disclosed system and method for live surveillance property monitoring, hereinafter referred to as Patroleum monitoring system,” or “Patroleum system.” The Patroleum monitoring system operates to monitor a large number of residential or commercial properties without the need for a correspondingly large number of monitoring personnel. In addition, the problem of false alarms is eliminated, or is greatly reduced.

In particular, the Patroleum system functions to watch and keep under surveillance, hundreds of: (i) residences, (ii) small businesses, (iii) legally-defined private properties, and/or (iv) other non-public areas simultaneously, without the need to constantly watch the video feed from each individual target. If any individual crosses the virtual fence from any direction or any height, jumping or walking over the line, virtual fence will trigger alarm.

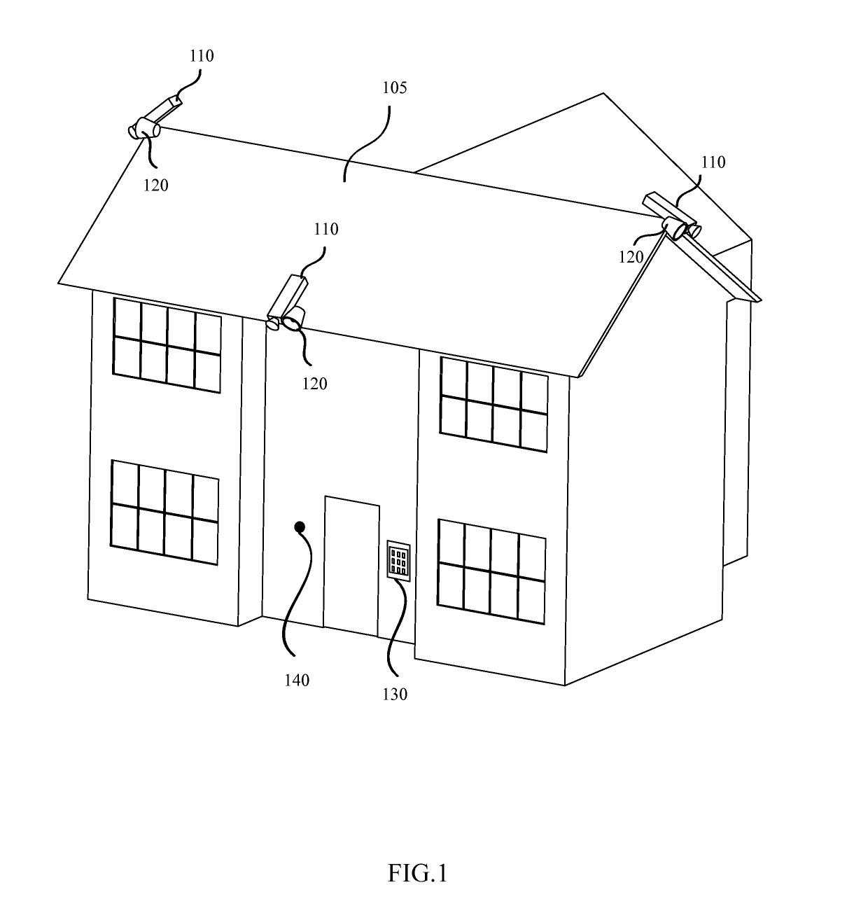

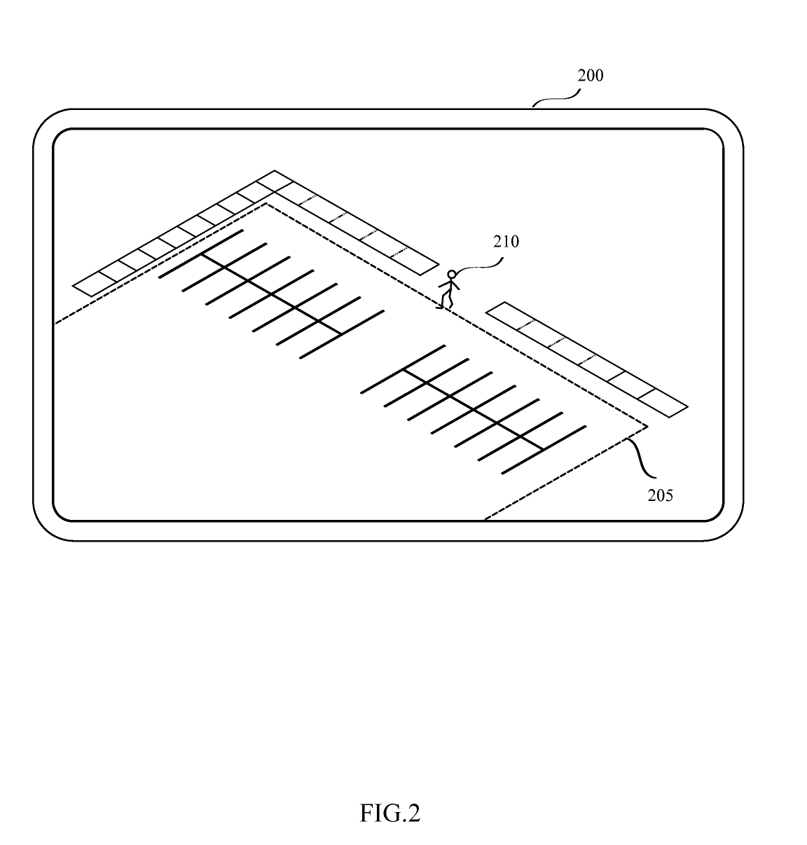

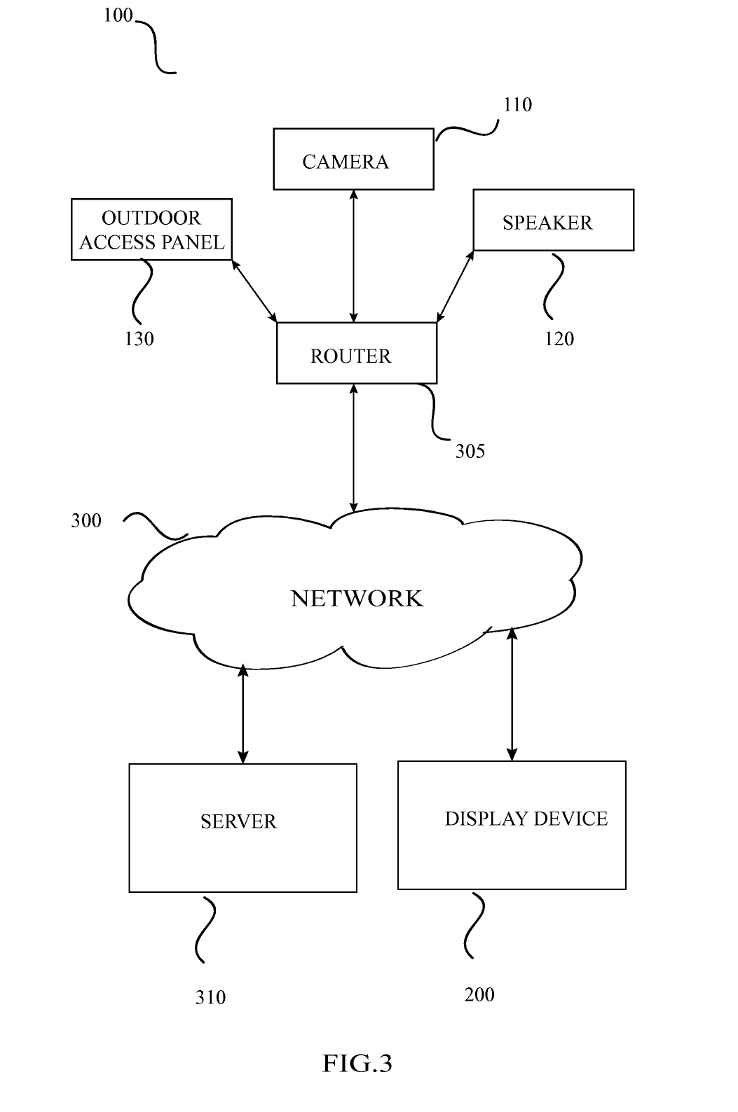

In an exemplary embodiment, shown in FIG. 1, FIG. 2 and FIG. 3 the disclosed Patroleum system may comprise one or more of the following functionalities and components:

1. Wireless or wired network 300 (preferably both)

2. Router(s) 305

3. Server or similar hardware 310

4. Video Management Software and Video Analytics Software both resident in the Server(s) 310

5. Strategically Positioned cameras or other Imaging Devices (preferably PTZ cameras) 110

6. Optional Speakers 120, strategically positioned

7. Outdoor access panel 130 accessible by the customer(s)

8. Optional microphone 140, strategically positioned.

As illustrated in FIG. 1, in a preferred embodiment of the Patroleum system, a plurality of cameras 110 are installed at preselected different positions on top of a house 105 of a customer of Patroleum system in such a way that the cameras 110 can capture the possible entrance areas of the property under surveillance. FIG. 1 also shows a plurality of speakers 120 positioned strategically on house 100. An outdoor access panel 130 and a microphone 140 are also shown in FIG. 1.

FIG. 3 illustrates exemplary embodiments of Patroleum system 100. As shown in FIG. 3, via network 300 the plurality of cameras 110, speakers 120 and outdoor access panel 130 are connected to a server 310 through a router 305. As is well known in the relevant art(s), routers forward packets between networks. The router 305 forwards information packets among the server 310 and the plurality of cameras 110, speakers 120 and outdoor access panel 130 over the network 300. In accordance with an embodiment of the present invention, the server 310 hosts a video management software and video analytics software. Also shown in FIG. 3 is a display device 200 of a client device which is connected to the server 310 through the network 300.

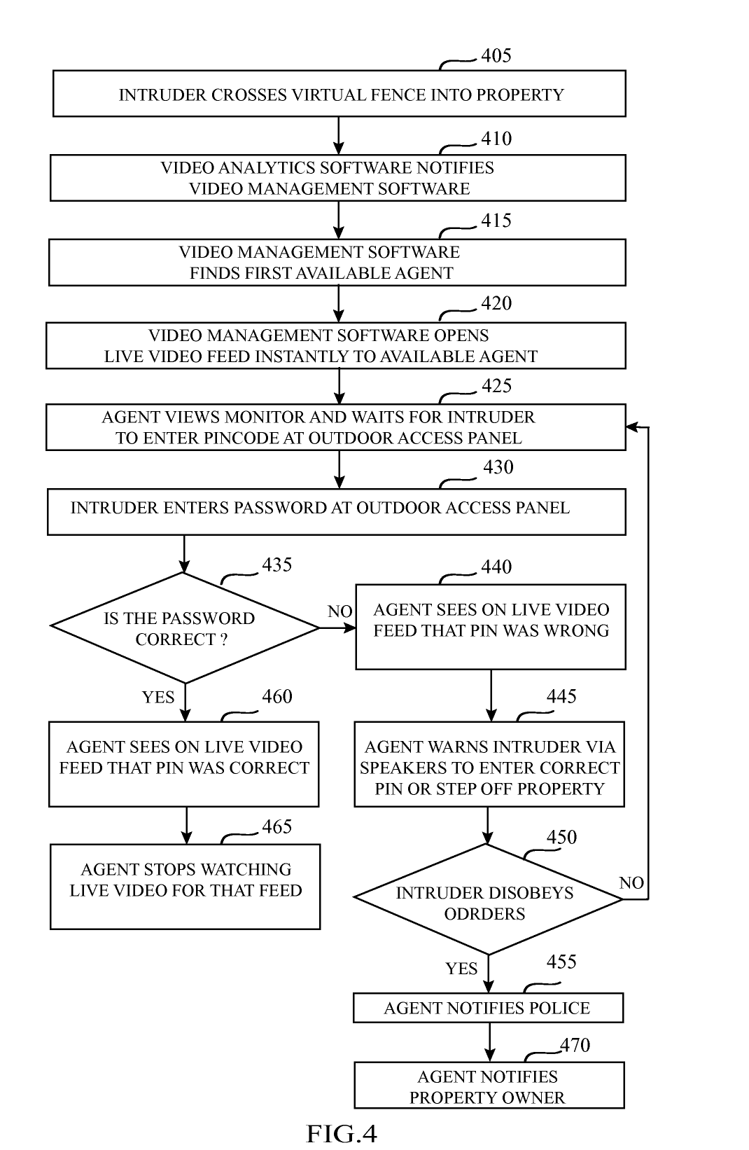

Reference to FIG. 1, FIG. 2, FIG. 3 and FIG. 4, when the Patroleum system 100 is turned on, the cameras 110 start capturing live video of the area surrounding the house 105. The video data thus captured is now transmitted to the server 310 through network 300. In a preferred embodiment of the present invention, although shown only one in the FIG. 3 for simplification, there will be plurality of display devices 200 installed at a centralized monitoring station manned by persons to monitor live video feed at display devices 200. The persons monitoring video feed on display devices 200 are referred to as agents hereinafter. The video analytic software residing at server 310 superimposes a virtual fence 210 on the video feed received from the cameras 110 around the periphery of the house 105. In a preferred embodiment of the present invention, when an intruder 210 crosses this virtual fence as in step 405, the video analytic software residing at server 110 detects such movement. The video management system residing at server 310 manages the video feeds received from the multiple cameras 110. Whenever a movement across the virtual fence 205 is detected by the video analytic software in a video feed transmitted by the cameras 110, the video analytics software notifies the video management software about such movement as in step 410. The video management software then determines as to which display device 200, among others installed at the monitoring station, the video is to be transmitted for display as per the availability of the agents as in step 415. Once the video management software finds an available agent, the video feed where a movement has been detected, is transmitted for display to that available agent on display device 200 as in step 420. The agent then monitors the activity of the intruder 210 on the display device 200 as in step 425. If the intruder 210 tries to break into the house 105 or does some activity which can be considered harmful to the property, the monitoring agent immediately warns the intruder 210 via speakers 120 and notifies police and the property owner immediately. Otherwise, the monitoring agent waits till the intruder enters access code or password at the outdoor access panel 130 as in step 430. If the password entered into outdoor access panel 130 by the intruder 210 is found to be correct after determining its correctness as in step 435, the agent monitoring the video is informed about it as in step 460 and subsequently the agent stops monitoring the video as in step 465 and the video feed is turned off. In the event of failure to enter the correct password into the outdoor access panel 130 by the intruder 210 the monitoring agent is informed as in step 440 about it. The agent then warns the intruder over the speakers 120 as in step 445 and waits to see whether the intruder 210 obeys his orders or not as in step 450. If the intruder 210 does not obey the order of the agent then the agent immediately notifies the law enforcement authorities of the area in which the property is located as in step 455. Finally the agent notifies the owner of the property or the representative of the property owner about the intrusion as in step 470.

In a preferred embodiment, the network 300 can be a wireless or wired network service which may be provided by a commercial entity such as Verizon, to provide Internet access and service to the router 305. Wired Internet, such as DSL, Cable and Fiber Optics can also be used, however 4G Internet is highly reliable, keeping the connection constant. Also, with a carrier such as Verizon, that covers 98% of America in 4G LTE, this makes it easier to roll out this solution on a nation-wide level. This also makes the solution more mobile, if a customer decides to cancel membership.

In another embodiment of the present invention, by providing the correct password into the outdoor access panel 130, a customer of the present invention can turn the Patroleum system on and off, as desired. In this manner, the Patroleum system may “authenticate” a person for entry into the monitored area when the correct password is entered by the person using an outdoor access panel.

This configuration enables the Patroleum monitoring station agents to see video feed in high definition, and essentially instantly (i.e., in real time). Accordingly, the router 305 functions to connect all the cameras and outdoor access panels within the Patroleum system 100. The server(s) may function to configure the router 130, cameras 110 and all equipment remotely. The router 305 may also be used by the Patroleum system 100 to configure the system components remotely.

One or more of the outdoor access panel 130 may be used as an access and alarming pad, allowing the using customer to turn live surveillance monitoring on or off at the customer premises. The speakers 120 may be connected to the cameras 110, so as to enable a monitoring station agent, or the customer, to initiate verbal directives at an intruder in real-time, if so desired. In an exemplary embodiment, a microphone 140 may be installed at the property under surveillance so as to enable voice communication to the agent from a person near the property under surveillance.

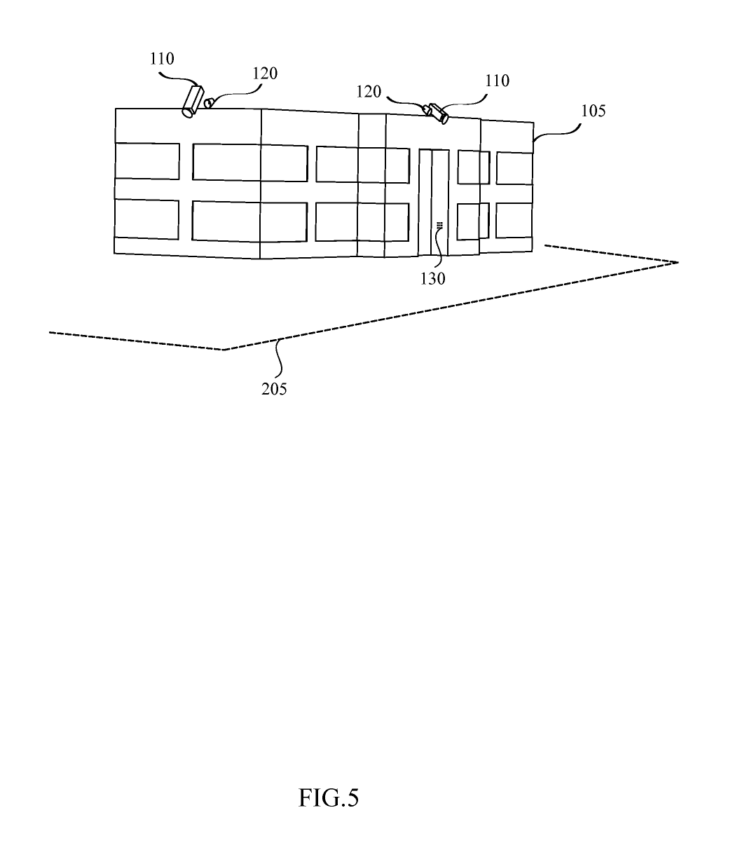

The Video Analytics Software functions to emplace a virtual (i.e., digitally generated) fence 205 around each monitored area shown in a video feed, as shown in FIG. 2 and in FIG. 5. In accordance with the Video Analytics Software, the virtual fence 205 is pre-defined for the respective customer by an agent of the Patroleum system. The resulting virtual fence 205 configuration is designed and adapted to the particular dwelling and property, preferably by using a validated or legal blueprint for the dwelling, structure, and/or property, to establish vulnerable areas. The Patroleum system agent may work from customer input and from the validated or legal blueprint for the dwelling, structure, and/or property to determine and define a desirable perimeter (i.e., virtual fence 205) at which an intrusion will initiate an alarm at the Patroleum monitoring station.

In an exemplary embodiment, the respective video cameras 110 are substantially stationary, and located so as to provide some degree of overlap between adjacent fields of view. This configuration, preferable for high-crime areas for example, provides video feed of the entire virtual fence at any instant of time. In an alternative embodiment, suitable for low-crime areas for example, one or more of the video cameras 110 may be panned to provide intermittent coverage of any one region of the monitored area. In this alternative embodiment, the virtual fence 205 is digitally created on the appropriate video feed as the position of the camera 110 is changed by the controlling Video Analytics Software. It should be understood that, in the alternative embodiment, the virtual fence 205 remains in place on the corresponding video image, and portions of the virtual fence may “disappear” and “reappear” as the panning movement of the cameras require.

If an intruder 210 passes through the virtual fence 205 and into the monitored area after the Patroleum system 100 has been emplaced and is operational, the Video Analytics Software responds to detection of the intrusion. This response by the Video Analytics Software initiates a process by which one or more video cameras 110 imaging the area of presumed intrusion begin sending live video feed to a Patroleum monitoring station, enabling a monitoring agent at a video display screen on display device 200 to verify in real time whether an intrusion is, or is not, in process. In addition, the Patroleum system 100 allows for validation or dismissal of false alarms by the monitoring agent who is viewing the live video feed of the area being displayed on one or more video display screens.

Unlike conventional monitoring systems, the Patroleum system 100 thus provides real-time video feed of the events occurring only in selected monitored area(s), and does not provide such video feed for an area in which the virtual fence has not been breached. In a preferred embodiment, the Video Analytics Software sends the live video feed to a next available monitoring agent for video analysis and response, if required. That is, agents who are “busy” are passed over, and a “ready” agent is selected for viewing the most recently-activated live video feed. In this manner, the Patroleum system 100 avoids the incidence of false alarms. However, if the Patroleum agent sees that a masked intruder is walking onto a monitored area at 3 AM, for example, the police are dispatched immediately.

As can be appreciated, the Patroleum system 100 represents a vast improvement over the conventional monitoring systems now being utilized. The virtual fence around the monitored area provides a means of watching houses, buildings, commercial property, and non-public areas in the hundreds without the need for a monitoring agent to continuously watch each residence, small business, private property, and/or non-public area individually. Since the fence provided by the Patroleum system 100 is a virtual one, it ensures that any movement occurring across the virtual fence 205 at any height from the ground level where the virtual fence 205 is being superimposed gets detected. The virtual fence 205 can be emplaced to provide protection not just to a house under surveillance but also to any other property such as a car lying inside the virtual fence.

The main key element to Patroleum system 100 is implementation of the virtual fence 205 on the homes blueprint. A primary feature of the Patroleum system 100 is the action initiated in response to suspicious activity identified on a particular live video feed. The action provides for the placement of the suspicious live feed into the queue, wherein the Patroleum system 100 determines which monitoring operator is available to respond to the next live feed in the queue.

These innovative features enable a relatively small number of monitoring agents to monitor properties and residences in the hundreds, rather than in the dozens, for example. A conventional motion-sensing system lacks reliability as such conventional systems typically respond to, for example: (i) customer pets that are outdoor animals, (ii) drive-by traffic, and (iii) pedestrians in the field of view of the monitoring cameras, where such normal activities may cause the conventional motion-sensing installation to be erroneously set off, resulting in a false alarm.

The virtual fence 205 is shown only to Patroleum system employees or agents at the monitoring station, that is, live video feed that has real time action happening on it, not just another false alarm. Queue distribution enables the Patroleum system 100 to monitor accounts in the thousands and millions, without resulting in monitoring stations becoming over flooded. Both methods function to insure that the live surveillance monitoring operation is complete and successful.

In an alternative embodiment, once the Patroleum system includes the virtual fence and the live video feed queue distribution, a wireless carrier may not be required, as a customer's Internet access may be sufficient. In addition, a customer's router may also be substituted for the Industrial router, and/or any other type of access pad may be used in place of the outdoor access panel 130. The Patroleum system 100 can also be used without speakers 120, which are optional peripheral items that can be used, for example, to tell a burglar get off the property, or to warn an intruder that the police are on their way.

As is known in the relevant art, for a monitoring agent to have the means to watch a series of twenty five properties, for example, the monitoring agent will need to rely on a queue system. For example, a call center may receive up to 1,000 calls. Successive calls need to be routed into a queue, and are then sent to the next available agent to respond.

In addition, the Patroleum system 100 may comprise different types of servers from those described above, so long as the Patroleum system 100 includes some type of device to run the Video Analytics Software. Cameras are required, as are the virtual fence and the live feed distribution on the software. These are required for proper operation of the Patroleum system 100.

The present invention thus provides a monitoring system essentially free from false alarms. Also, the present invention provides greater security for a user's property when compared to conventional monitoring systems. The Patroleum system doesn't wait for the burglar to break a window or open a door for the alarm to go off. By incorporation of the virtual fence and live feed distribution queue, as disclosed herein, the monitored area received immediate human attention as soon as an intruder encroaches onto the customer's legal property. The Patroleum system reacts to watch the property in real time, assess what's going on, and determines if the intruder can be authenticated by entering the PIN on an outdoor tablet access pad.

Additionally, other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for live surveillance property monitoring, the system comprising:
at least one camera installed strategically on a property under surveillance for capturing a video;
at least one server hosting at least one video management software and at least one video analytics software;
at least one network for providing data communication access;
at least one router for forwarding data over said network;
at least one display device for displaying said video;
at least one outdoor access panel for turning on and off said system; and
at least one speaker for announcements;
wherein a virtual fence is superimposed on said video captured through said at least one camera by said at least one video analytics software wherein said at least one video is forwarded by said at least one router to said at least one server through said at least one network whereby any movement occurring across said virtual fence is detected by said at least one video analytics software and said at least one video management software then transmits said video to said at least one display device for monitoring by an agent at a monitoring station whereby said agent takes appropriate action according to situation.

2. The system for live surveillance property monitoring as in claim 1, wherein said network is wireless.

3. The system for live surveillance property monitoring as in claim 1, wherein said network is wired.

4. The system for live surveillance property monitoring as in claim 1, wherein said appropriate action by said agent is giving verbal directive to an intruder through said at least one speaker in real time.

5. The system for live surveillance property monitoring as in claim 1, wherein said appropriate action by said agent is notifying law enforcement agency in real time.

6. The system for live surveillance property monitoring as in claim 1, wherein said appropriate action by said agent is notifying owner of said property under surveillance in real time.

7. The system for live surveillance property monitoring as in claim 1, wherein said system monitors a large number of residences, small businesses, legally-defined private properties, and other non-public areas without the need for a correspondingly large number of said monitoring station agent.

8. The system for live surveillance property monitoring as in claim 1, wherein said system provides said real-time video feed of the events occurring in said selected monitored areas and does not provide such said video feed for an area in which said virtual fence has not been breached.

9. The system for live surveillance property monitoring as in claim 1, wherein said video is sent into a queue and from said queue said video is sent to the next available said agent for monitoring at said display device installed at said monitoring station for said appropriate action.

10. A method for live surveillance property monitoring, the method comprising:
positioning at least one camera strategically on a property under surveillance for capturing a video;
hosting by at least one server at least one video management software and at least one video analytics software;
providing data communication access by at least one network;
forwarding data over said network by at least one router;
displaying said video by at least one display device;
turning on and off a system by at least one outdoor access panel; and
announcing by said at least one speaker;
wherein a virtual fence is superimposed on said video captured through said at least one camera by said at least one video analytics software wherein said at least one video is forwarded by said at least one router to said at least one server through said at least one network whereby any movement occurring across said virtual fence is detected by said at least one video analytics software and said at least one video management software then transmits said video to said at least one display device for monitoring by an agent at a monitoring station whereby said agent takes appropriate action according to situation.

11. The method for live surveillance property monitoring as in claim 10, wherein said network is wireless.

12. The method for live surveillance property monitoring as in claim 10, wherein said network is wired.

13. The method for live surveillance property monitoring as in claim 10, wherein said appropriate action by said agent is giving verbal directive to an intruder through said at least one speaker in real time.

14. The method for live surveillance property monitoring as in claim 10, wherein said appropriate action by said agent is notifying law enforcement agency in real time.

15. The method for live surveillance property monitoring as in claim 10, wherein said appropriate action by said agent is notifying owner of said property under surveillance in real time.

16. The method for live surveillance property monitoring as in claim 10, further comprises monitoring a large number of residences, small businesses, legally-defined private properties, and other non-public areas without the need for a correspondingly large number of said monitoring station agent.

17. The method for live surveillance property monitoring as in claim 10, further comprises providing said real-time video feed of the events occurring in said selected monitored areas and does not provide such said video feed for an area in which said virtual fence has not been breached.

18. The method for live surveillance property monitoring as in claim 10, further comprises sending said video into a queue and from said queue sending said video to the next available said agent for monitoring at said display device installed at said monitoring station for said appropriate action.
